(19) United States
(12) Patent Application Publication
(10) Pub. No.: US 2003/0148794 A1
(43) Pub. Date: Aug. 7, 2003

(54) Cellular communications tower connection device

(76) Inventor: Charles M. Wilson JR., Hiram, GA (US)

Correspondence Address: NEEDLE & ROSENBERG P C, 127 PEACHTREE STREET N E, ATLANTA, GA, 30303-1811, US

(21) Appl. No.: 10/061,782

(22) Filed: Feb. 1, 2002

(51) Int. Cl. H04Q 7/20

(52) U.S. Cl. 455/562; 455/422

(57) ABSTRACT

An electronic switching device connected between a base station antenna tower and the base station electronics allows an operator to selectably connect external equipment, such as a Cell-On-Wheels (COW).

### BACKGROUND OF THE INVENTION

1. Field of the Invention

The present invention relates generally to cellular telephone communications systems and, more specifically, to antenna and electronics interconnections at a cell site base station.

2. Description of the Related Art

At each cell site of a cellular telephone system, there is a base station that includes a group of antennas connected to base station electronics. The electronics at each cell site communicate with a centralized mobile telephone switching office (MTSO) at another location, which in turn communicates with the public switched telephone network (PSTN). As illustrated in FIG. 1, the base station electronics 10 are typically housed in a weatherproof shelter or enclosure 12 (shown in a partially cut-away view to illustrate electronics 10 inside). Cables 14 extending between enclosure 12 and the antenna tower 16 carry signals between electronics 10 and the antennas 18. Antennas 18 are typically grouped into three sectors, sometimes referred to as alpha, beta and gamma, with each sector of antennas arrayed along a side of an equilateral triangle centered on the tower, so as to provide an essentially omnidirectional overall antenna pattern. The total number of antennas 18 is thus typically between six and twelve. Therefore, at least that number of conductors exist in cables 14 between enclosure 12 and antennas 18. In addition, each cable 14 may include its own ground conductor 20 attached to a ground rod. Cables 14 are typically bundled together and run along a so-called ice bridge 22, which is a protective metal catwalk-like structure extending between enclosure 12 and antenna tower 16.

Often, it is necessary to test, upgrade, and otherwise service electronics 10 or antennas 18. For example, to test antennas 18, technicians can disconnect cables 14 from electronics 10. Such maintenance is typically performed in late evening or early morning to minimize disruption of telephone service. Typically, disconnecting cables 14 is a laborious process, involving technicians manually disconnecting individual conductors inside enclosure 12, freeing cables 14 from the cable ties and cable hangers along ice bridge 22, and in some cases even unwrapping insulation layers on cables 14 to disconnect ground conductors 20. As illustrated in FIG. 2, the disconnected ends of cables 14 can then be connected to a mobile electronics vehicle known as a Cell-On-Wheels (COW) 24. COW 24 typically includes electronics that emulate the base station electronics. Thus, COW 24 can be driven to a cell site and temporarily connected in place of base station electronics 10. Connecting COW 24 in this manner can allow the cell site to remain on-line while technicians service electronics 10. Thus, maintenance can be performed during daytime hours without significantly disrupting telephone service.

The entire system is grounded, and ground conductors 20 are commonly tapped somewhere along the length of each cable 14 between enclosure 10 and antenna tower 16 and connected together and to ice bridge 22 physically and electrically. Ground conductors 20 tapped in this manner further contribute to the unwieldy jumble of cables 14 tied to ice bridge 22 and can further frustrate disconnecting them from electronics 10 and connecting them to COW 24.

It would be desirable to enhance the ease with which a COW or other such external equipment is used at a cell site base station and to generally improve the maintainability of a base station. The present invention addresses these problems and deficiencies and others in the manner described below.

### SUMMARY OF THE INVENTION

The present invention relates to an electronic switching device that can be connected between one or more base station antennas and the base station electronics. The device has three sets of connectors or other terminals: a first set is connected to the antennas; a second set is connected to the base station electronics; and the third set can be connected to any suitable external equipment that may be brought to the base station site for equipment diagnosis, test, repair, replacement, addition, setup or other purposes. The switching device has a plurality of switches that are associated with the antennas. Each switch can be set to one of at least two states. In a first state, the switch couples the antenna to the base station electronics. In a second state, the switch couples the antenna to the external equipment. Other states, such as coupling an antenna to both the external equipment and the base station electronics or coupling the base station electronics to the external equipment are also contemplated. This switching action can be controlled electronically in any suitable manner, such as by providing the switching device with a keypad control. Switches can be controlled individually or in groups to correspondingly switch the antennas independently of one another or together in one or more groups. As used in this patent specification, the term “switch” refers not only to electromechanical and solid-state relay-like devices, but also any other automatically or manually operated devices that can switch antenna signals in the manner described above.

It is to be understood that both the foregoing general description and the following detailed description are exemplary and explanatory only, and are not restrictive of the invention as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates a prior art cell site base station;

FIG. 2 illustrates the prior art base station with a Cell-On-Wheels (COW) connected;

FIG. 3 illustrates a cell site base station system in accordance with the present invention, with a COW connected;

FIG. 4 illustrates an embodiment of a switching device of the present invention; and

FIG. 5 is a generalized schematic diagram of the switching device in accordance with an embodiment of the present invention.

### DETAILED DESCRIPTION

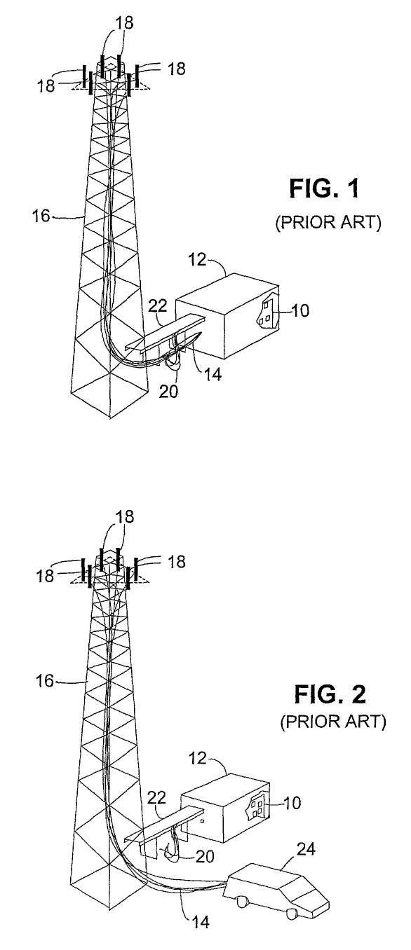

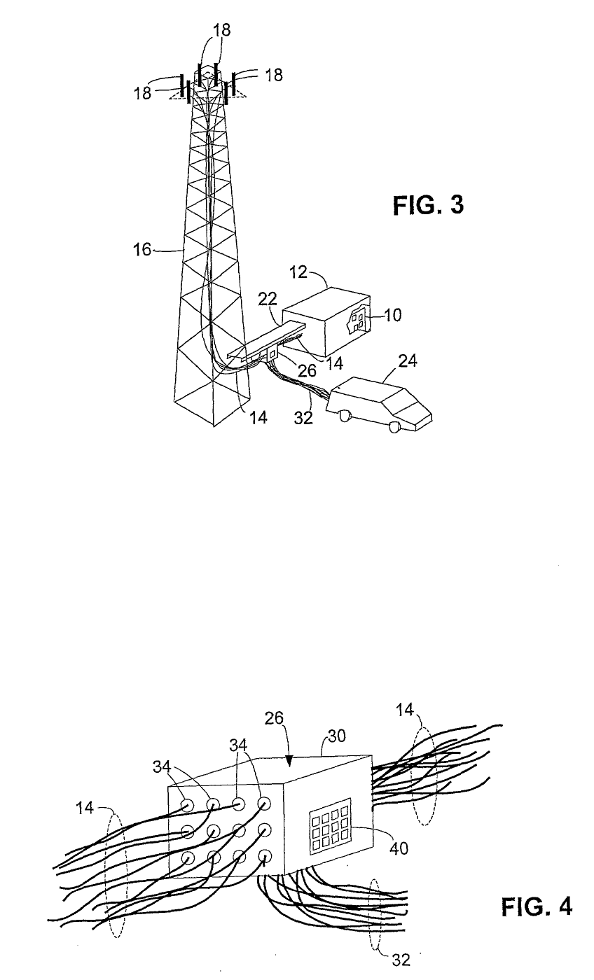

As illustrated in FIG. 3, a switching device 26 is connected between base station electronics 10 and antennas 18. Electronics 10 are of the conventional type included in cell site base stations and are housed in weatherproof enclosure 12 in the conventional manner. Antennas 18 are also of the conventional type and are supported by tower 16 in the conventional manner. Although tower 16 is shown for purposes of illustrated, the antennas 18 can be supported and located in any manner known in the art, such as on a rooftop, water tower, monopole, guy tower, etc. Cables 14 extend between each antenna 18 and device 26 and between device 26 and enclosure 12. To retrofit an existing or conventional base station of the type illustrated in FIG. 1, personnel can thus disconnect cables 14 from electronics 10, re-connect them to device 26, and connect other such cables 14 from device 26 to electronics 10. Ice bridge 22 can be used to support device 26. There can be any suitable number and type of antennas 18, as known in the art. Nevertheless, to facilitate illustration of an exemplary embodiment of the invention, it can be assumed there are twelve antennas 18, each of which is coupled to one of cables 14. Antennas 18 are grouped into pairs, with one antenna 18 of the pair carrying a transmit (“TX”) signal and the other carrying a receive (“RX”) signal. Each sector includes such a pair of antennas 18. Thus, in this example there is a total of six such signals carried on six corresponding cables 14. In other base stations, however, there may a greater number of antenna pairs per sector. For example, there may be a total of twelve such signals (or any other suitable number), with the signals associated with each sector referred to as “RX0,” “RX1,” “TX0” and “TX1.”

Device 26 is shown separately in FIG. 4. Device 26 is housed in a suitable weatherproof enclosure 30. Device 26 can be connected by cables 32 to Cell-On-Wheels (COW) 24. Device 26 has suitable connectors 34, such as standard coaxial cable connectors, on its enclosure 30 to which cables 14 can readily be connected. Similar connectors (not shown) on the underside of enclosure 30 connect cables 32 from COW 24. Inside enclosure 30, the ground conductor or shield of each connector 34 is electrically connected to those of the others, and the resulting common ground is electrically connected (e.g., by a large copper strap) to enclosure 30. Enclosure 30 can in turn be conveniently connected by such a grounding strap (not shown) to ice bridge 22, tower 16, a grounding rod (not shown) or any other suitable part of the base station to achieve proper grounding. Thus, the invention obviates awkwardly tapping off cable 14 and attaching a grounding cable 20 as in the prior art system of FIG. 1.

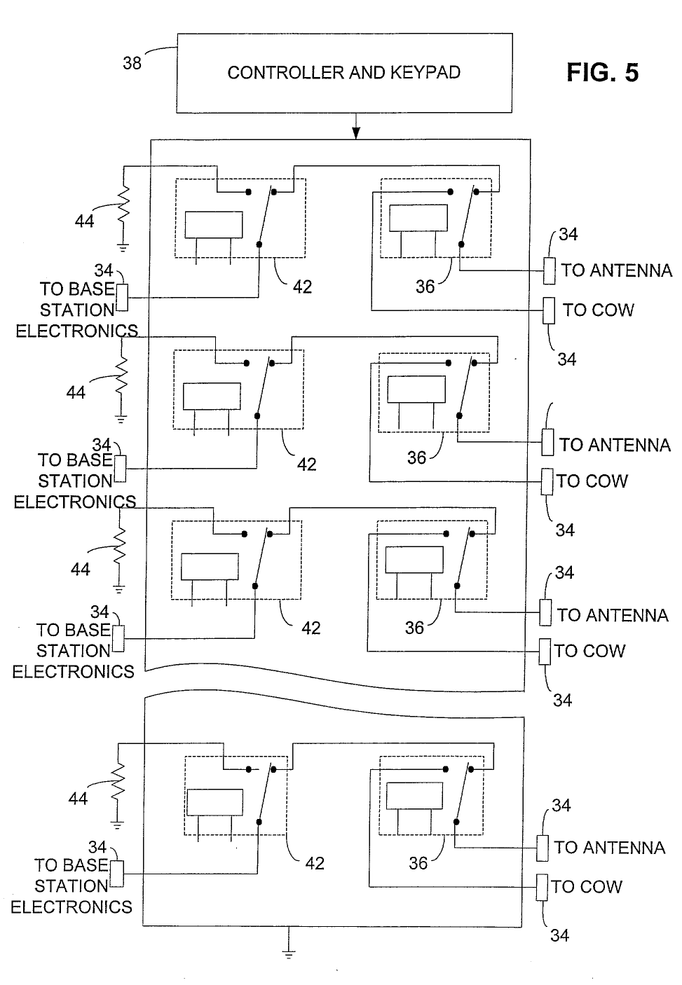

As illustrated in FIG. 5, device 26 includes suitable solid-state or, alternatively, electromechanical antenna switches 36 within enclosure 30. Although twelve switches 36 are shown in this embodiment of the invention, in a base station of the type described above in which a total of only six signals are carried on cables 14, six of switches 36 can remain unused. In other embodiments of the invention, device 26 can include any other suitable number of switches 26. Although depicted symbolically as relays in FIG. 5 for purposes of illustration, antenna switches 36 can be any suitable device that can perform the switching function described below. Each antenna switch 36 corresponds to one antenna 18; thus, in the exemplary embodiment there are twelve antenna switches 36. Each antenna switch 36 is connected to a controller and keypad subsystem 38, which can be a separate circuit board from that of switches 36. Controller and keypad subsystem 38 includes suitable control circuitry, such as a programmable logic or a suitably programmed microcontroller or microprocessor (not shown). Persons skilled in the art to which the invention relates are readily capable of providing and using a suitable microcontroller-based controller and keypad subsystem 38. Subsystem 38 includes a suitable numeric, alphanumeric or other keypad 40 (FIG. 4) on which an operator can press buttons to control the switching action of device 26. For example, if the operator presses a particular predetermined sequence of one or more buttons, all switches 36 are set to a first state in which all six antennas 18 are coupled to COW 24. If the operator presses another predetermined sequence of one or more buttons, all switches 36 are set to a second state in which all six antennas 18 are coupled to electronics 10. If the operator presses yet another sequence of one or more buttons, some subset of switches 36, such as only those associated with antennas 18 of a particular sector, are coupled to CQW 24, with the remaining switches 36 coupled to electronics 10. In other words, in some embodiments of the invention, the operator can have control over the state of each individual switch 36 or individual groups of switches 36. In some embodiments, it may be desirable to control switches 36 together in groups, such as those associated with one of the three sectors, those associated with only the TX signals or only the RX signals, and so forth. Various other such modes of operation will occur readily to persons skilled in the art to which the invention relates and can readily be programmed or otherwise configured in subsystem 38 in view of these teachings. Note that the use of COW 24 or other such external equipment is only exemplary; device 26 can be used simply to selectively decouple antennas 18 from electronics 10 in a convenient and reliable manner. In normal operation of the base station, device 26 provides straight-through connectivity to maintain antennas 18 coupled to electronics 10.

It is also contemplated that keypad controller and keypad subsystem 38 can be used for additional purposes in some embodiments of the invention. For example, it can disable any switching until an operator enters a predetermined security code on keypad 40.

Device 26 can also include load switches 42 of the same or similar type as antenna switches 36. Load switches 42 are similarly controlled by subsystem 38 via operator input on keypad 40. Load switches 42 allow an operator to couple any signal from base station electronics 10 to a dummy load 44 instead of an antenna 18. Like antenna switches 36, load switches 42 can be controlled individually or, alternatively or in addition, in groups. For example, if the operator presses a predetermined sequence of one or more buttons, antennas 18 or some subset thereof are decoupled from electronics 10 and dummy loads 44 substituted in their place.

The present invention allows personnel to quickly and easily connect external equipment into a cell site base station system without having to undo a disorderly jumble of cables that may not have standard connectors. The invention also provides a convenient and orderly grounding mechanism that obviates awkward tapping of cables.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A method for selectably connecting an external device at a cell site, comprising the steps of:
connecting each of a plurality of first terminals a switching device disposed at a cell site to a cell site antenna;
connecting each of a plurality of second terminals of the switching device to cell site electronics;
connecting of a plurality of third terminals of the switching device to an external cell site maintenance device; and
setting each of a plurality of antenna switches to a selected one of at least two antenna states, in a first antenna state a first terminal connected to a second terminal, and in a second antenna state a first terminal connected to a third terminal.

2. The method claimed in claim 1, wherein the setting step comprises setting an electronically-controlled switch in response to input provided by an operator on a control panel.

3. The method claimed in claim 2, wherein the control panel receives the input via a keypad.

4. The method claimed in claim 3, further comprising the step of decoding the input to determine which of the plurality of antenna switches to set to the first state and which of the plurality of antenna switches to set to the second state.

5. The method claimed in claim 3, further comprising the step of enabling the setting step in response to an authorized security code provided by an operator via the keypad.

6. The method claimed in claim 1, wherein each of the connecting steps comprises connecting a coaxial cable connector.

7. The method claimed in claim 1, further comprising the step of setting each of a plurality of load switches to a selected one of at least two load states, in a first one of the load states a second terminal is connected to an antenna switch, and in a second one of the states the second terminal is connected to a dummy load and not to an antenna switch.

8. The method claimed in claim 1, wherein the step of connecting each of a plurality of third terminals to an external cell site maintenance device comprises connecting each third terminal to a Cell On Wheels.

9. A method for retrofitting a cell site base station with a switching device, comprising the steps of:
disposing the switching device at a cell site, the switching device comprising an enclosure, a plurality of first terminals on the enclosure, a corresponding plurality of second terminals on the enclosure, a corresponding plurality of third terminals on the enclosure, a corresponding plurality of electronically-controlled antenna switches within the enclosure, and an operator control panel, each antenna switch having at least two operator-selectable antenna states selectable via the control panel, in a first one of the antenna states a first terminal connected to a second terminal, and in a second one of the antenna states a first terminal connected to a third terminal;
connecting each first terminal to a cell site antenna; and
connecting each second terminal to cell site electronics.

10. A switching apparatus for a cell site base station, comprising:
an enclosure;
a plurality of first terminals on the enclosure;
a plurality of second terminals on the enclosure, each second terminal corresponding to a first terminal;
a plurality of third terminals on the enclosure, each third terminal corresponding to a first terminal and a second terminal;
a plurality of electronically-controlled antenna switches within the enclosure, each antenna switch corresponding to a first terminal, a second terminal and a third terminal; and
an operator control panel, each antenna switch having at least two operator-selectable antenna states selectable via the control panel, in a first one of the antenna states a first terminal connected to a second terminal, and in a second one of the antenna states a first terminal connected to a third terminal.

11. The system claimed in claim 10, further comprising a plurality of electronically-controlled load switches within the enclosure, each load switch corresponding to a second terminal and having at least two operator-selectable load states selectable via the control panel, in a first one of the load states a second terminal is connected to an antenna switch, and in a second one of the load states the second terminal is connected to a dummy load.

12. The system claimed in claim 10, wherein the first, second and third terminals include ground conductors connected to each other in the enclosure and connected to the enclosure.
